(19) United States
(12) Patent Application Publication
(10) Pub. No.: US 2026/0081058 A1
(43) Pub. Date: Mar. 19, 2026

(54) COIL COMPONENT

(71) Applicant: KABUSHIKI KAISHA TOYOTA JIDOSHOKKI, Aichi (JP)

(72) Inventors: Kenichi NAGAYOSHI, Aichi (JP); Naoki IWATA, Aichi (JP)

(73) Assignee: KABUSHIKI KAISHA TOYOTA JIDOSHOKKI, Aichi (JP)

(21) Appl. No.: 19/318,980

(22) Filed: Sep. 4, 2025

(30) Foreign Application Priority Data
Sep. 18, 2024 (JP) 2024-161114

(51) Int. Cl. H01F 5/04; H01F 27/28

(52) U.S. Cl. CPC H01F 5/04; H01F 27/2847

(57) ABSTRACT

A coil component includes a first coil portion formed by flatwise winding of a first flat wire around an axial line extending in a first direction, a first end portion having one end and drawn out from an inner periphery of the first coil portion, and a second end portion having the other end and drawn out from an outer periphery of the first coil portion. The first end portion has a first bending portion formed by edgewise bending of the first flat wire from the inner periphery and extending beyond the first coil portion in the first direction and a first extending portion formed by flatwise bending of the first flat wire from the first bending portion and extending in a second direction intersecting with the first direction.

### CROSS-REFERENCE TO RELATED APPLICATION

This application claims priority to Japanese Patent Application No. 2024-161114 filed on Sep. 18, 2024, the entire disclosure of which is incorporated herein by reference.

### BACKGROUND ART

The present disclosure relates to a coil component.

A coil component including a pair of coil elements and a coupling portion is described in Japanese Patent Application Publication No. 2016-039322. Here, the coil elements are each formed in multiple layers by flatwise winding of a winding wire made of conductor having a rectangular-shaped cross-section. In each coil element, one end of the winding wire is located in the innermost periphery of the coil element, and a portion of the winding wire having its other end is drawn out from the outermost periphery of the coil element. The one ends of the winding wires are coupled to each other through the coupling portion.

The coil component described in the Publication has a multilayered structure in order to draw out the portion of the wiring wire having its coil end. This may increase the coil component in size.

The present disclosure describes a coil component that can be decreased in size.

### SUMMARY

In accordance with an aspect of the present disclosure, there is provided a coil component that includes a first coil portion formed by flatwise winding of a first flat wire around an axial line extending in a first direction so that the first coil portion has a single layer in the first direction, a first end portion having one end of the first flat wire and drawn out from an inner periphery of the first coil portion, and a second end portion having the other end of the first flat wire and drawn out from an outer periphery of the first coil portion. The first end portion has a first bending portion formed by edgewise bending of the first flat wire from the inner periphery of the first coil portion and extending beyond the first coil portion in the first direction and a first extending portion formed by flatwise bending of the first flat wire from the first bending portion and extending in a second direction intersecting with the first direction.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a perspective view illustrating a schematic configuration of a transformer to which a coil component according to an embodiment is applied;

FIG. 2 is a cross-sectional view taken along a line II-II in FIG. 1;

FIG. 3 is a perspective view of the coil component illustrated in FIG. 1;

FIG. 4 is a perspective view illustrating a schematic configuration of a transformer to which a coil component according to another embodiment is applied;

FIG. 5 is an exploded perspective view of the coil component illustrated in FIG. 4;

FIG. 6A is a side view of the coil component illustrated in FIG. 4; and

FIG. 6B is a plan view of the coil component illustrated in FIG. 4.

### DETAILED DESCRIPTION OF THE EMBODIMENTS

The following will describe coil components according to some embodiments with reference to the accompanying drawings. In the description of the drawings, identical or substantially identical components have the same reference numerals, and are not reiterated. An XYZ coordinate system may be illustrated in each drawing. A Y-axis direction (second direction) is a direction that intersects with (for example, perpendicular to) an X-axis direction (third direction) and a Z-axis direction (first direction). The Z-axis direction is a direction that intersects with (for example, perpendicular to) the X-axis direction and the Y-axis direction. In the following description, as an example, the X-axis direction is defined as a left-right direction (width direction), the Y-axis direction is defined as a front-rear direction (depth direction), and the Z-direction is defined as an up-down direction (height direction). The X-axis direction, the Y-axis direction, and the Z-axis direction are not limited to the above-described directions.

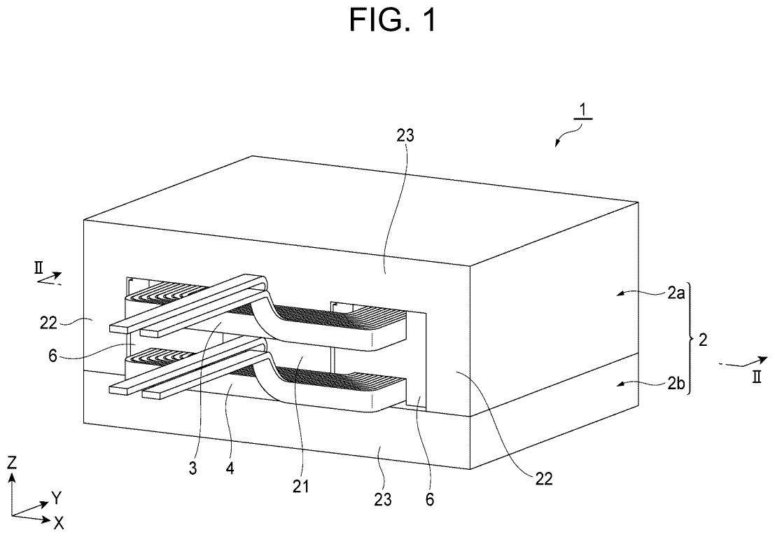

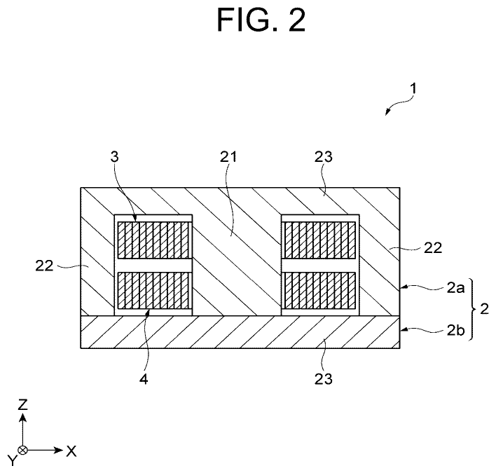

The following will describe a schematic configuration of a transformer to which a coil component according to an embodiment is applied with reference to FIG. 1 and FIG. 2. FIG. 1 is a perspective view illustrating the schematic configuration of the transformer to which the coil component according to the embodiment is applied. FIG. 2 is a cross-sectional view taken along a line II-II in FIG. 1. A transformer 1 illustrated in FIG. 1 and FIG. 2 is a device that converts a primary voltage to a secondary voltage and includes a core 2, a primary winding 3, and a secondary winding 4, and bobbins 6. Note that illustrations of the bobbins 6 are omitted in FIG. 2.

The core 2 is a magnetic body that forms magnetic paths. The core 2 includes a center leg portion 21, a pair of side leg portions 22, and a pair of coupling portions 23. The center leg portion 21 and the pair of the side leg portions 22 each extend in the up-down direction. The center leg portion 21 and the pair of the side leg portions 22 are arranged in substantially in parallel to each other. The pair of the side leg portions 22 is provided away from the center leg portion 21 on opposite sides thereof in the left-right direction. That is, the center leg portion 21 is interposed between the pair of the side leg portions 22. The pair of the coupling portions 23 is portions that connect the pair of the side leg portions 22 to the center leg portion 21. The coupling portions 23 each have a flat plate shape. One of the coupling portions 23 connects one end of the center leg portion 21 to one end of each of the side leg portions 22. The other of the coupling portions 23 connects the other end of the center leg portion 21 to the other end of each of the side leg portions 22.

In the present embodiment, the core 2 is an EI core formed of a core member 2a having an E-shape and a core member 2b having an I-shape. The core 2 is not limited to an EI core, and may be an EE core or a PQ core.

The primary winding 3 and the secondary winding 4 are coil components each formed by winding a band-shaped flat wire in a spiral shape. The primary winding 3 and the secondary winding 4 are flatwise coils each formed by winding the flat wire while bending the flat wire in a thickness direction of the flat wire. The thickness direction of the flat wire is a direction along a short side of a cross-section of the flat fire intersecting with (for example, perpendicular to) a direction in which the flat wire extends. The primary winding 3 and the secondary winding 4 are wound around the center leg portion 21. The secondary winding 4 is provided away from the primary winding 3 in the up-down direction. The primary winding 3 and the secondary winding 4 have the same structures. The primary winding 3 and the secondary winding 4 will be described in detail later.

The bobbins 6 are members that hold the primary winding 3 and the secondary winding 4. The bobbins 6 are each made of an insulating material. Examples of the insulating material of the bobbins 6 include resin such as plastic. The bobbins 6 electrically insulate the primary winding 3 from the secondary winding 4 and electrically insulate the primary winding 3 and the secondary winding 4 from the core 2. The transformer 1 further includes path cores that are provided between the primary winding 3 and the secondary winding 4 in the up-down direction. The pass cores are magnetic bodies that form, together with the core 2, magnetic paths through which leakage magnetic flux passes. In this case, the path cores may be each accommodated in the corresponding bobbins 6.

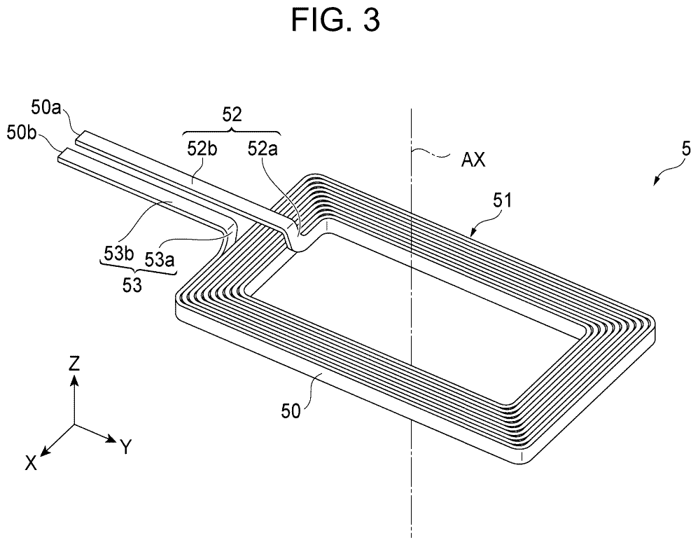

The following will describe a coil component 5 corresponding to the primary winding 3 and the secondary winding 4 with reference to FIG. 3. FIG. 3 is a perspective view of the coil component illustrated in FIG. 1. As illustrated in FIG. 3, the coil component 5 is formed of one flat wire 50 (first flat wire) and includes a coil portion 51 (first coil portion), an end portion 52 (first end portion), and an end portion 53 (second end portion). The flat wire 50 is formed of a conductive member (for example, copper) having a rectangular-shaped cross section intersecting with (for example, perpendicular to) a direction in which the flat wire 50 extends and an insulating film covering a surface of the conductive member.

The coil portion 51 is formed by flatwise winding of the flat wire 50 around an axial line AX extending in the up-down direction. In the flatwise winding, a flat wire is wound while being bent in the thickness direction of the flat wire. In the coil portion 51, the flat wire 50 is wound so that the coil portion 51 has a single layer in the up-down direction. In other words, in the coil portion 51, the flat wire 50 is wound in a spiral shape on the same plane. In the present embodiment, the coil portion 51 has a rectangular outline in plan view.

The end portion 52 has one end 50a of the flat wire 50 and is a portion drawn out from an inner periphery of the coil portion 51. The end portion 52 further has a bending portion 52a (first bending portion) and an extending portion 52b (first extending portion). The bending portion 52a is formed by edgewise bending of the flat wire 50 from the inner periphery of the coil portion 51 and extends beyond the coil portion 51 (an upper end of the coil portion 51) upward in the up-down direction. In the edgewise bending, a flat wire is bent in a width direction of the flat wire. The width direction of the flat wire is a direction along a long side of a cross-section of the flat wire intersecting with (for example, perpendicular to) the direction in which the flat wire extends. The extending portion 52b is continuous with an upper end of the bending portion 52a. The extending portion 52b is formed by flatwise bending of the flat wire 50 from the bending portion 52a and extends forward. In the flatwise bending, a flat wire is bent in the thickness direction of the flat wire. The extending portion 52b extends forward from the inner peripheral of the coil portion 51 beyond an outer periphery of the coil portion 51.

The end portion 53 has the other end 50b of the flat wire 50 and is a portion drawn out from the outer periphery of the coil portion 51. The end portion 53 further has a bending portion 53a (second bending portion) and an extending portion 53b (second extending portion). The bending portion 53a is formed by the edgewise bending of the flat wire 50 from the outer periphery of the coil portion 51 and extends beyond the coil portion 51 (the upper end of the coil portion 51) upward in the up-down direction. In the present embodiment, an upper end of the bending portion 53a and the upper end of the bending portion 52a are located substantially at the same height in the up-down direction. The extending portion 53b is continuous with the upper end of the bending portion 53a. The extending portion 53b is formed by the flatwise bending of the flat wire 50 from the bending portion 53a and extends forward. The extending portion 53b and the extending portion 52b are arranged in the left-right direction, and located substantially at the same height in the up-down direction. The extending portion 52b and the extending portion 53b extend substantially in parallel to each other.

A posture (orientation) of the flat wire 50 in the extending portion 52b is substantially the same as that of the flat wire 50 in the extending portion 53b. That is, both of the width direction of the flat wire 50 in the extending portion 52b and the width direction of the flat wire 50 in the extending portion 53b are the left-right direction, and both of the thickness direction of the flat wire 50 in the extending portion 52b and the thickness direction of the flat wire 50 in the extending portion 53b are the up-down direction.

As described above, in the coil component 5, the coil portion 51 is formed by the flatwise winding of the flat wire 50 around the axial line AX extending in the up-down direction so that the coil portion 51 has the single layer in the up-down direction. The end portion 52 having the one end 50a of the flat wire 50 is drawn out from the inner periphery of the coil portion 51, and the end portion 53 having the other end 50b of the flat wire 50 is drawn out from the outer periphery of the coil portion 51. In the end portion 52, the bending portion 52a is formed by the edgewise bending of the flat wire 50 from the inner periphery of the coil portion 51 and extends beyond the coil portion 51 in the up-down direction, and the extending portion 52b is formed by the flatwise bending of the flat wire 50 from the bending portion 52a and extends forward. Thus, the end portion 52 is drawn out from the inner periphery of the coil portion 51 without interfering with the coil portion 51. With this configuration, the coil portion 51 need not have multiple layers in the up-down direction, so that it is possible to decrease in size (lower profile) of the coil component 5.

As illustrated in FIG. 2, when the coil component 5 is adopted as the primary winding 3 and the secondary winding 4, the primary winding 3 and the secondary winding 4 each have a single layer in the up-down direction. This shortens a magnetic path length and decreases in size (lower profile) of the transformer 1 in the up-down direction.

In the end portion 53, the bending portion 53a is formed by the edgewise bending of the flat wire 50 from the outer periphery of the coil portion 51, and the extending portion 53b is formed by the flatwise bending of the flat wire 50 from the bending portion 53a and extends forward. This configuration aligns a posture (orientation) of the flat wire 50 in the extending portion 53b with the posture of the flat wire 50 in the extending portion 52b. Accordingly, the coil component 5 is easily mounted on a board or the like.

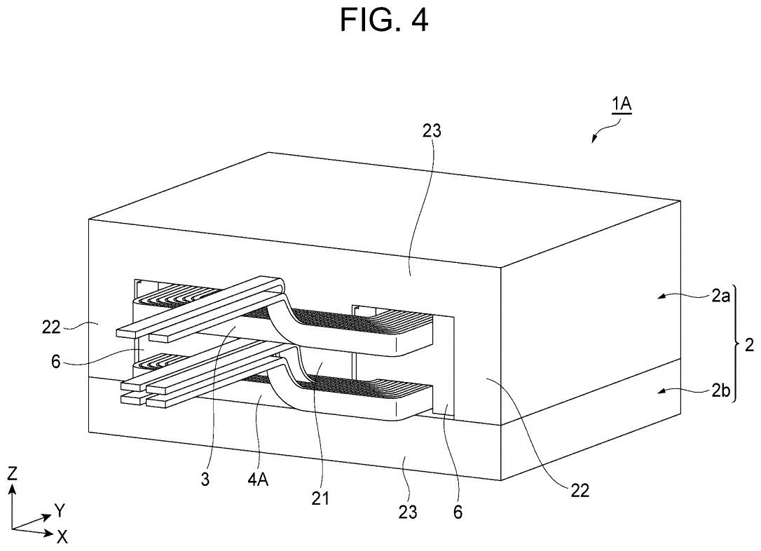

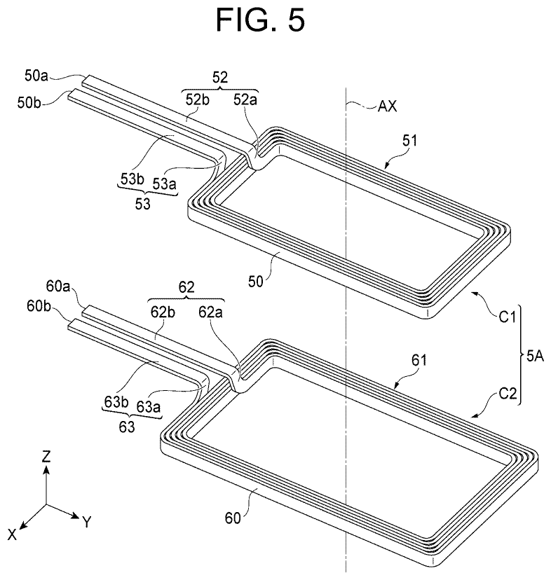

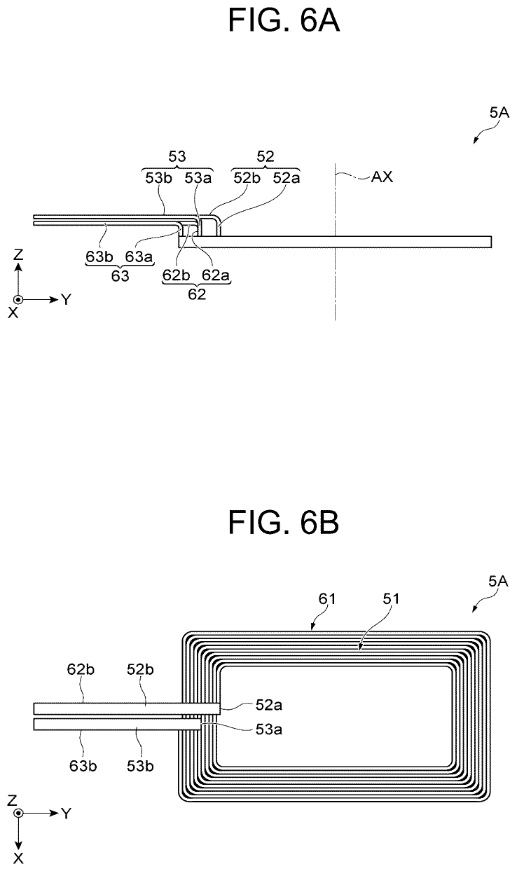

The following will describe a coil component according to another embodiment with reference to FIGS. 4, 5, 6A, and 6B. FIG. 4 is a perspective view illustrating a schematic configuration of a transformer to which the coil component according to another embodiment is applied. FIG. 5 is an exploded perspective view of the coil component illustrated in FIG. 4. FIG. 6A is a side view of the coil component illustrated in FIG. 4. FIG. 6B is a plan view of the coil component illustrated in FIG. 4.

A transformer 1A illustrated in FIG. 4 is different from the transformer 1 mainly in that the transformer 1A includes a secondary winding 4A instead of the secondary winding 4. The secondary winding 4A is different from the secondary winding 4 mainly in that a coil component 5A instead of the coil component 5 corresponds to the secondary winding 4A.

As illustrated in FIG. 5, the coil component 5A is different from the coil component 5 mainly in that the coil component 5A includes the coil component 5 as an inner coil C1 and further includes an outer coil C2. That is, the secondary winding 4A has a structure in which the inner coil C1 and the outer coil C2 are to be connected in parallel to each other. The outer coil C2 is formed of one flat wire 60 (second flat wire) and includes a coil portion 61 (second coil portion), an end portion 62 (third end portion), and an end portion 63 (fourth end portion). Similarly to the flat wire 50, the flat wire 60 is formed of a conductive member (for example, copper) having a rectangular-shaped cross section intersecting with (for example, perpendicular to) a direction in which the flat wire 60 extends and an insulating film covering a surface of the conductive member.

The coil portion 61 is formed by the flatwise winding of the flat wire 60 around the axial line AX. The coil portion 51 is surrounded by the coil portion 61. More specifically, an inner periphery of the coil portion 61 is located along the outer periphery of the coil portion 51. In the coil portion 61, the flat wire 60 is wound so that the coil portion 61 has a single layer in the up-down direction. In other words, in the coil portion 61, the flat wire 60 is wound in a spiral shape on the same plane as that on which the coil portion 51 is wound. In the present embodiment, the coil portion 61 has a rectangular outline in plan view.

The end portion 62 has one end 60a of the flat wire 60 and is a portion drawn out from the inner periphery of the coil portion 61. The end portion 62 further has a bending portion 62a (third bending portion) and an extending portion 62b (third extending portion). The bending portion 62a is formed by the edgewise bending of the flat wire 60 from the inner periphery of the coil portion 61 and extends beyond the coil portion 61 (an upper end of the coil portion 61) upward in the up-down direction. The extending portion 62b is continuous with an upper end of the bending portion 62a. The extending portion 62b is formed by the flatwise bending of the flat wire 60 from the bending portion 62a and extends forward. The extending portion 62b extends forward from the inner periphery of the coil portion 61 beyond an outer periphery of the coil portion 61.

The end portion 63 has the other end 60b of the flat wire 60 and is a portion drawn out from the outer periphery of the coil portion 61. The end portion 63 has a bending portion 63a and an extending portion 63b. The bending portion 63a is formed by the edgewise bending of the flat wire 60 from the outer periphery of the coil portion 61 and extends beyond the coil portion 61 (the upper end of the coil portion 61) upward in the up-down direction. In the present embodiment, an upper end of the bending portion 63a and the upper end of the bending portion 62a are located at substantially the same height in the up-down direction. The extending portion 63b is continuous with the upper end of the bending portion 63a. The extending portion 63b is formed by the flatwise bending of the flat wire 60 from the bending portion 63a and extends forward. The extending portion 63b and the extending portion 62b are arranged in the left-right direction, and located substantially at the same height in the up-down direction. The extending portion 62b and the extending portion 63b extend substantially in parallel to each other.

A posture (orientation) of the flat wire 60 in the extending portion 62b is substantially the same as that of the flat wire 60 in the extending portion 63b. That is, both of the width direction of the flat wire 60 in the extending portion 62b and the width direction of the flat wire 60 in the extending portion 63b are the left-right direction, and both of the thickness direction of the flat wire 60 in the extending portion 62b and the thickness direction of the flat wire 60 in the extending portion 63b are the up-down direction.

As illustrated in FIG. 6A, the bending portion 52a extends upward beyond the bending portion 62a, and the extending portion 52b is located above the extending portion 62b. As illustrated in FIG. 6B, the extending portion 52b is overlapped with the extending portion 62b as viewed in the up-down direction (in plan view). In other words, the extending portion 52b and the extending portion 62b are arranged in the up-down direction and extend forward in parallel to each other.

Similarly, as illustrated in FIG. 6A, the bending portion 53a extends upward beyond the bending portion 63a, and the extending portion 53b is located above the extending portion 63b. As illustrated in FIG. 6B, the extending portion 53b is overlapped with the extending portion 63b as viewed in the up-down direction (in plan view). In other words, the extending portion 53b and the extending portion 63b are arranged in the up-down direction and extend forward in parallel to each other.

As illustrated in FIG. 6A, the bending portion 53a and the bending portion 62a are located at the same position in the front-rear direction and arranged in the left-right direction.

As described above, also in the coil component 5A, the same configuration as that of the coil component 5 provides the same advantageous effects as those of the coil component 5. The coil component 5A includes the inner coil C1 and the outer coil C2. Also in the outer coil C2, the coil portion 61 is formed by the flatwise winding of the flat wire 60 around the axial line AX extending in the up-down direction so that the coil portion 61 has the single layer in the up-down direction. The end portion 62 having the one end 60a of the flat wire 60 is drawn out from the inner periphery of the coil portion 61, and the end portion 63 having the other end 60b of the flat wire 60 is drawn out from the outer periphery of the coil portion 61. In the end portion 62, the bending portion 62a is formed by the edgewise bending of the flat wire 60 from the inner periphery of the coil portion 61 and extends beyond the coil portion 61 in the up-down direction, and the extending portion 62b is formed by the flatwise bending of the flat wire 60 from the bending portion 62a and extends forward. Thus, the end portion 62 is drawn out from the inner periphery of the coil portion 61 without interfering with the coil portion 61. With this configuration, the coil portion 61 need not have multiple layers in the up-down direction, so that it is possible to decrease in size (lower profile) of the coil component 5A.

In the end portion 63, the bending portion 63a is formed by the edgewise bending of the flat wire 60 from the outer periphery of the coil portion 61, and the extending portion 63b is formed by the flatwise bending of the flat wire 60 from the bending portion 63a and extends forward. This configuration aligns a posture (orientation) of the flat wire 60 in the extending portion 63b with the posture of the flat wire 60 in the extending portion 62b. Accordingly, the coil component 5A is easily mounted on a board, or the like.

In addition, in the coil component 5A, the bending portion 53a of the inner coil C1 and the bending portion 62a of the outer coil C2 are arranged in the left-right direction. With this configuration, a space between the coil portion 51 (inner coil C1) and the coil portion 61 (outer coil C2) is reduced. Accordingly, it is possible to further decrease in size of the coil component 5A.

The extending portion 52b is overlapped with the extending portion 62b as viewed in the up-down direction (in plan view). With this configuration, the extending portion 52b and the extending portion 62b are close to each other, so that the extending portion 52b and the extending portion 62b are easily joined to each other. Similarly to the extending portion 52b, the extending portion 53b is overlapped with the extending portion 63b as viewed in the up-down direction (in plan view). With this configuration, the extending portion 53b and the extending portion 63b are close to each other, so that the extending portion 53b and the extending portion 63b are easily joined to each other. As a result, the inner coil C1 and the outer coil C2 are easily connected in parallel to each other.

Since the inner coil C1 and the outer coil C2 are to be connected in parallel to each other, a current flowing through the secondary winding 4A is decreased by half. This reduces losses and heat generated at the secondary winding 4A.

The embodiments of the present disclosure are described above in detail; however, the coil components according to the present disclosure are not limited to the above-described embodiments.

For example, the end portion 52 and the end portion 53 of the coil component 5 are drawn out forward; however, a direction in which the end portion 52 is drawn out and a direction in which the end portion 53 is drawn out are not limited to forward. The direction in which the end portion 52 is drawn out and the direction in which the end portion 53 is drawn out may be the same or different from each other.

The extending portion 52b may be located at a different position from that of the extending portion 53b in the up-down direction. In the coil component 5, the bending portion 53a need not extend upward beyond the upper end of the coil portion 51. Similarly, the extending portion 62b may be located at a different position from that of the extending portion 63b in the up-down direction. The bending portion 63a need not extend upward beyond the upper end of the coil portion 61.

The posture (orientation) of the flat wire 50 in the extending portion 52b may be different from the posture of the flat wire 50 in the extending portion 53b. For example, in the coil component 5, the end portion 53 need not have the bending portion 53a and may directly extend forward from the outer periphery of the coil portion 51. In this case, a process of the edgewise bending is not required for the end portion 53, so that manufacturing of the coil component 5 becomes simple.

The posture of the flat wire 60 in the extending portion 62b may be different from the posture of the flat wire 60 in the extending portion 63b. For example, in the coil component 5A, the end portion 63 need not have the bending portion 63a and may directly extend forward from the outer periphery of the coil portion 61. In this case, the process of the edgewise bending is not required for the end portion 63, so that the manufacturing of the coil component 5A becomes simple.

The core 2 may protrude forward so as to cover the coil portion 51 of the primary winding 3. In this case, the core 2 has a shape in which the core 2 does not interfere with the end portion 52 and the end portion 53. The coil component 5A instead of the coil component 5 may correspond to the primary winding 3.

What is claimed is:

1. A coil component comprising:
a first coil portion formed by flatwise winding of a first flat wire around an axial line extending in a first direction so that the first coil portion has a single layer in the first direction;
a first end portion having one end of the first flat wire and drawn out from an inner periphery of the first coil portion; and
a second end portion having the other end of the first flat wire and drawn out from an outer periphery of the first coil portion, wherein the first end portion has:
a first bending portion formed by edgewise bending of the first flat wire from the inner periphery of the first coil portion and extending beyond the first coil portion in the first direction; and
a first extending portion formed by flatwise bending of the first flat wire from the first bending portion and extending in a second direction intersecting with the first direction.

2. The coil component according to claim 1, wherein
the second end portion has:
a second bending portion formed by the edgewise bending of the first flat wire from the outer periphery of the first coil portion; and,
a second extending portion formed by the flatwise bending of the first flat wire from the second bending portion and extending in the second direction.

3. The coil component according to claim 2, further comprising:
a second coil portion formed by the flatwise winding of a second flat wire around the axial line so that the second coil portion has a single layer in the first direction, the second coil portion surrounding the first coil portion;
a third end portion having one end of the second flat wire and drawn out from an inner periphery of the second coil portion; and
a fourth end portion having the other end of the second flat wire and drawn out from an outer periphery of the second coil portion, wherein
the third end portion has:
a third bending portion formed by the edgewise bending of the second flat wire from the inner periphery of the second coil portion and extending beyond the second coil portion in the first direction; and
a third extending portion formed by the flatwise bending of the second flat wire from the third bending portion and extending in the second direction, and
the second bending portion and the third bending portion are arranged in a third direction intersecting with the first direction and the second direction.

4. The coil component according to claim 3, wherein
the first extending portion is overlapped with the third extending portion as viewed in the first direction.
